(19) United States
(12) Patent Application Publication
(10) Pub. No.: US 2016/0121690 A1
(43) Pub. Date: May 5, 2016

(54) APPARATUS AND METHOD FOR CONTROLLING COOLING

(71) Applicants: Hyundai Motor Company, Seoul (KR); Kia Motors Corporation, Seoul (KR)

(72) Inventor: Hyun Kim, Hwaseong-si (KR)

(73) Assignees: Hyundai Motor Company, Seoul (KR); Kia Motors Corporation, Seoul (KR)

(21) Appl. No.: 14/838,934

(22) Filed: Aug. 28, 2015

(30) Foreign Application Priority Data
Nov. 3, 2014 (KR) 10-2014-0151568

(51) Int. Cl. B60H 1/00; F02D 41/08

(52) U.S. Cl. CPC B60H 1/00764; F02D 41/083

(57) ABSTRACT

An apparatus for controlling cooling may include a deciding device configured to decide an idle revolution per minute (RPM) control mode by comparing an outdoor temperature measured by a temperature sensor and a predefined set value with each other when an air conditioner operating request is present in an idle control state of a vehicle, a mode setting device configured to set the idle RPM control mode to at least one of a first mode and a second mode, an RPM compensating device configured to adjust an idle RPM to a first value at a time of setting the idle RPM control mode to the first mode and adjust the idle RPM to a second value at a time of setting the idle RPM control mode to the second mode, and a controller configured to control a cooling operation of an air conditioner.

### CROSS-REFERENCE TO RELATED APPLICATION

The present application claims priority to Korean Patent Application No. 10-2014-0151568, filed Nov. 3, 2014, the entire contents of which is incorporated herein for all purposes by this reference.

### BACKGROUND OF THE INVENTION

1. Field of the Invention

The present invention relates to an apparatus and a method for controlling cooling, and more particularly, to a technology of variably controlling an idle revolution per minute (RPM) depending on an outdoor temperature.

2. Description of Related Art

An idle revolution per minute (RPM) of a vehicle is set based on basic performance of the vehicle such as idle stability, vibrations, fuel efficiency, and the like. In the case of a high-level vehicle, the idle RPM has been lowered to improve an idle comfortable ride and fuel efficiency.

Recently, a problem that cooling performance is insufficient in summer has been continuously raised in vehicles exported to the Middle East. Therefore, an effort to improve air conditioner cooling performance at the time of idle-stopping the vehicle during driving the vehicle in a hot season has been required. To this end, in the case of the vehicles exported to the Middle East, an idle RPM of the vehicle has been raised at the time of operating an air conditioner to improve idle stability and cooling performance.

However, since this algorithm is applied to only a zone in which a temperature is always high, such as the Middle East, data on the vehicles exported to the Middle East should be managed separately from those of general vehicles.

In addition, in the case of lowering the idle RPM in a zone in which an outdoor temperature is high only in summer rather than a hot zone such as the Middle East, cooling performance in summer is decreased, while in the case of raising the idle RPM, high cooling performance is not required in seasons other than summer, such that an idle comfortable ride and fuel efficiency are deteriorated.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing an apparatus and a method for controlling cooling capable of optimizing cooling performance by variably controlling an idle revolution per minute (RPM) depending on an outdoor temperature.

According to various aspects of the present invention, an apparatus for controlling cooling may include a deciding device configured to decide an idle revolution per minute (RPM) control mode by comparing an outdoor temperature measured by a temperature sensor and a predefined set value with each other when an air conditioner operating request is present in an idle control state of a vehicle, a mode setting device configured to set the idle RPM control mode to at least one of a first mode and a second mode depending on the decision of the deciding device, an RPM compensating device configured to adjust an idle RPM to a first value at a time of setting the idle RPM control mode to the first mode and adjust the idle RPM to a second value at a time of setting the idle RPM control mode to the second mode, depending on the setting of the idle RPM control mode of the mode setting device, and a controller configured to control a cooling operation of an air conditioner depending on the idle RPM set value adjusted by the RPM compensating device.

The deciding device may decide the idle RPM control mode to be the first mode in a case in which the outdoor temperature measured by the temperature sensor exceeds the predefined set value.

The deciding device may decide the idle RPM control mode to be the second mode in the case in which the outdoor temperature measured by the temperature sensor does not exceed the predefined set value.

The first value may be larger than the second value.

The second value may be a reference idle RPM.

According to various aspects of the present invention, a method for controlling cooling may include deciding, by a deciding device, an idle RPM control mode by comparing an outdoor temperature measured by a temperature sensor and a predefined set value with each other when an air conditioner operating request is present in an idle control state of a vehicle, setting, by a mode setting device, the idle RPM control mode to any one of a first mode and a second mode depending on the decision, adjusting, an RPM compensating device, an idle RPM to a first value at the time of setting the idle RPM control mode to the first mode and adjusting the idle RPM to a second value at the time of setting the idle RPM control mode to the second mode, and controlling, by a controller, a cooling operation of an air conditioner depending on the adjusted idle RPM set value.

In the deciding of the idle RPM control mode, the idle RPM control mode may be decided to be the first mode in a case in which the outdoor temperature measured by the temperature sensor exceeds the predefined set value.

In the deciding of the idle RPM control mode, the idle RPM control mode may be decided to be the second mode in a case in which the outdoor temperature measured by the temperature sensor does not exceed the predefined set value.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuel derived from resources other than petroleum). As referred to herein, a hybrid vehicle is a vehicle that has two or more sources of power, for example, both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a block diagram illustrating a configuration of an exemplary apparatus for controlling cooling according to the present invention.

FIG. 2 is an illustrative view illustrating cooling performance depending on an idle revolution per minute (RPM).

FIG. 3A and FIG. 3B are illustrative views for describing a mode operation of the exemplary apparatus for controlling cooling according to the present invention.

FIG. 4 is a flow chart illustrating an operation flow of an exemplary method for controlling cooling according to the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

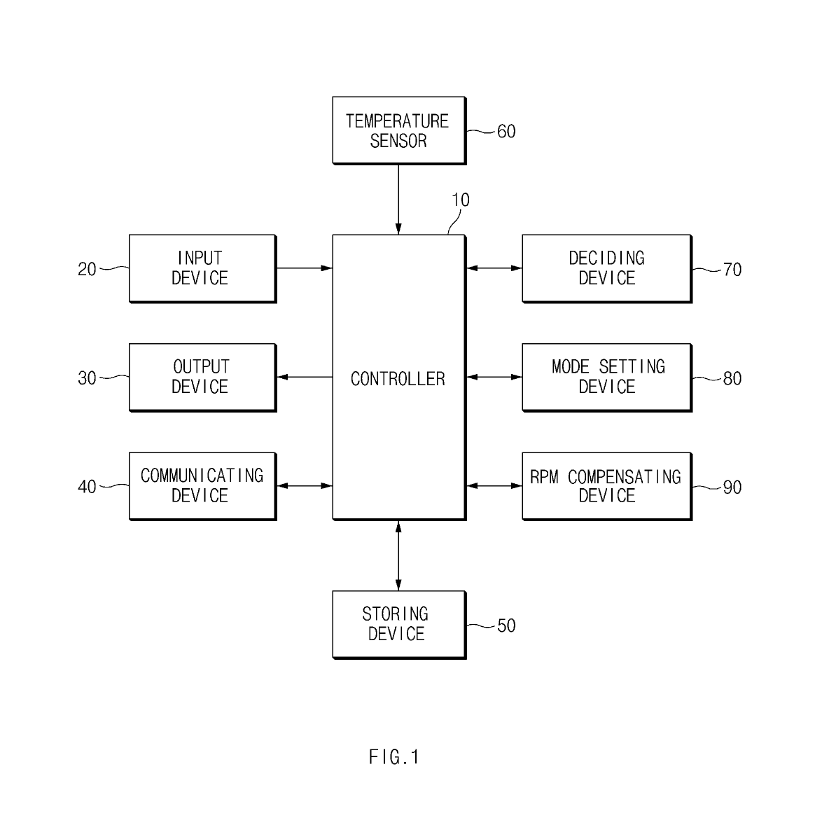

FIG. 1 is a block diagram illustrating a configuration of an apparatus for controlling cooling according to various embodiments of the present invention.

The apparatus for controlling cooling according to various embodiments of the present invention may be implemented in a vehicle. Here, the apparatus for controlling cooling may be formed integrally with internal control units of the vehicle or be implemented as a separate apparatus and be connected to the internal control units of the vehicle by separate connecting means. Here, the apparatus for controlling cooling may be operated in association with a cooling apparatus provided in the vehicle, for example, an air conditioner.

Therefore, referring to FIG. 1, the apparatus for controlling cooling according to various embodiments of the present invention may be configured to include a controller 10, an input device 20, an output device 30, a communicating device 40, a storing device 50, a temperature sensor 60, a deciding device 70, a mode setting device 80, and a revolution per minute (RPM) compensating device 90. Here, the controller 10 may process signals transferred between the respective devices of the apparatus for controlling cooling.

The input device 20, which is a means receiving a control command input from a user, may be a key button provided outside the apparatus for controlling cooling or on an instrument panel of the vehicle or a soft key implemented on a screen of the apparatus for controlling cooling or a display provided on an RV. In addition, the input device 20 may be an input means such as a mouse, a joy stick, a jog shuttle, or a stylus pen.

The output device 30 may include a display displaying an operation state, an operation performing result, and the like, of the apparatus for controlling cooling. As an example, the display may display idle control information, idle RPM control mode information, set idle RPM information, and the like, of the vehicle. In addition, the display may also display outdoor temperature information measured by the temperature sensor 60, indoor temperature information depending on an idle RPM control, and the like.

Here, in the case in which the display includes a sensor sensing a touch operation, it may be used as an input apparatus in addition to an output apparatus. That is, in the case in which a touch sensor such as a touch film, a touch sheet, a touch pad, or the like, is provided in the display, the display may be operated as a touch screen and be implemented in a form in which the input device 20 and the output device 30 are integrated with each other.

Here, the display may include at least one of a liquid crystal display (LCD), a thin film transistor-liquid crystal display (TFT LCD), an organic light-emitting diode (OLED), a flexible display, a field emission display (FED), and a 3D display.

In addition, the display may be an apparatus implemented separately from the apparatus for controlling cooling or may be an apparatus provided in the vehicle and connected to the apparatus for controlling cooling.

The communicating device 40 may include a communication module supporting a communication interface with electronic components and/or controllers provided in the vehicle. As an example, the communication module may be communicatively connected to the display, the air conditioner, and the like, provided in the vehicle to transmit an operation state and an operation performing result of the air conditioner to the display and transmit a control signal of the apparatus for controlling cooling to the air conditioner.

Here, the communicating device 40 may include a communication module supporting vehicle network communication such as controller area network (CAN) communication, local interconnection network (LIN) communication, flex-ray communication, or the like.

In addition, the communicating device 40 may also include a module for wireless Internet access or a module for short range communication. Here, a wireless Internet technology may include wireless local area network (WLAN), wireless broadband (Wibro), Wi-Fi, world interoperability for microwave access (Wimax), high speed downlink packet access (HSDPA), and the like, and a short range communication technology may include Bluetooth, ZigBee, ultra wideband (UWB), radio frequency identification (RFID), infrared data association (IrDA), and the like. In addition, a wired communication technology may include universal serial bus (USB) communication, or the like.

The storing device 50 may store a set value for an operation of the apparatus for controlling cooling therein. As an example, the storing device 50 may store a temperature set value predefined in order to decide an idle RPM control mode therein, and store an operation condition of the idle RPM control mode, for example, an idle RPM set value in a first mode, an idle RPM set value in a second mode, and the like, therein. In addition, the storing device 50 may also store a command for controlling the air conditioner of the vehicle depending on an operation in the idle RPM control mode, or the like, therein. In addition, the storing device 50 may also store an algorithm controlling the idle RPM operation mode depending on an outdoor temperature therein.

Here, the storing device 50 may include at least one storing medium of a flash memory type memory, a hard disk type memory, a multimedia card micro type memory, a card type memory (for example, an SD memory, an XD memory, or the like), a magnetic memory, a magnetic disk, an optical disk, a random access memory (RAM), a static random access memory (SRAM), a read-only memory (ROM), a programmable read-only memory (PROM), and an electrically erasable programmable read-only memory (EEPROM).

The temperature sensor 60 may include each of a sensor measuring an indoor temperature of the vehicle and a sensor measuring an outdoor temperature of the vehicle. Here, the temperature sensor 60 may measure the outdoor temperature of the vehicle in real time. In addition, the temperature sensor 60 may also measure the outdoor temperature of the vehicle by a request of the deciding device 70 when the request of the deciding device 70 is present, for example, in the case in which an air conditioner operation request is present in an idle control state of the vehicle. The temperature sensor may be generally any means that may measure a temperature of air.

The deciding device 70 decides whether the air conditioner operation request is present in the idle control state of the vehicle. When the air conditioner operation request is present from the user in the idle control state of the vehicle, the deciding device 70 may request the temperature sensor 60 to input outdoor temperature information.

When the outdoor temperature information is input from the temperature sensor 60, the deciding device 70 compares an outdoor temperature measured by the temperature sensor 60 and a predefined set value with each other and decides an idle RPM control mode depending on a comparison result.

Here, the deciding device 70 decides the idle RPM control mode to be a first mode in the case in which the outdoor temperature measured by the temperature sensor 60 exceeds the predefined set value. Meanwhile, the deciding device 70 decides the idle RPM control mode to be a second mode in the case in which the outdoor temperature measured by the temperature sensor 60 does not exceed the predefined set value. As an example, it is assumed that the first mode is a hot zone mode and the second mode is a general mode.

The deciding device 70 transfers information on the decided idle RPM control mode to the mode setting device 80.

Therefore, the mode setting device 80 sets the idle RPM control mode to any one of the first mode and the second mode depending on the decision of the deciding device 70. In other words, the idle RPM control mode is set to the first mode in the case in which the outdoor temperature exceeds the predefined set value and is set to the second mode in the case in which the outdoor temperature does not exceed the predefined set value. Information on the set idle RPM control mode may be stored in the storing device 50.

Although the case in which the idle RPM control mode is set to any one of the first mode and the second mode depending on the outdoor temperature has been described in the exemplary embodiment of the present invention, the idle RPM control mode may be divided into three or more modes depending on the outdoor temperature and be set to any one of the three or more modes in another exemplary embodiment of the present invention.

The RPM compensating device 90 adjusts an idle RPM depending on the setting of the idle RPM control mode by the mode setting device 80. In the case in which the idle RPM control mode is set to the first mode, the RPM compensating device 90 adjusts the idle RPM to a first value. In the case in which the idle RPM control mode is set to the second mode, the RPM compensating device 90 adjusts the idle RPM to a second value.

As an example, it is assumed that the second value is a reference idle RPM and the first value is larger than the second value. For example, the first value may be 800 RPM, and the second value may be 580 RPM. These values are only examples, and the present invention is not limited thereto. The idle RPM set value adjusted by the RPM compensating device 90 may be stored in the storing device 50.

The controller 10 controls a cooling operation of the air conditioner depending on the idle RPM set value adjusted by the RPM compensating device 90. As an example, in the case in which the idle RPM control mode is set to the first mode, the controller 10 generates a control signal for controlling an idle cooling operation of the air conditioner based on the first value and outputs the control signal to the air conditioner. Meanwhile, in the case in which the idle RPM control mode is set to the second mode, the controller 10 generates a control signal for controlling an idle cooling operation of the air conditioner based on the second value and outputs the control signal to the air conditioner.

Therefore, the air conditioner performs the idle cooling operation while adjusting a reference value of the idle RPM depending on the outdoor temperature.

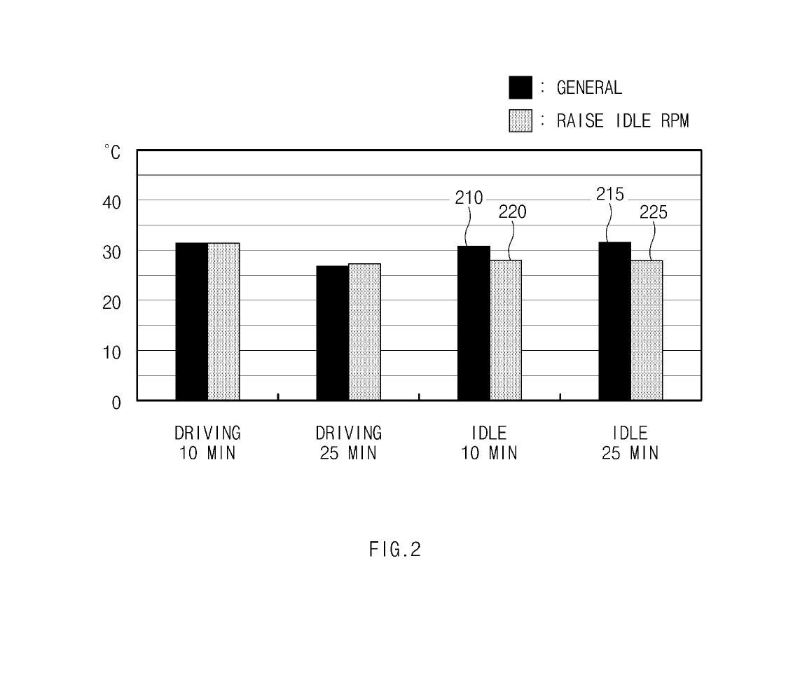

FIG. 2 is an illustrative view illustrating cooling performance depending on an idle RPM.

In FIG. 2, which illustrates cooling performance depending on the idle RPM set value in the case in which the outdoor temperature exceeds the predefined set value, there is no difference in cooling performance between the case in which the idle RPM control mode is set to the first mode and the case in which the idle RPM control mode is set to the second mode in a driving state.

However, when reviewing the case in which ten minutes elapse in an idle state, it may be appreciated that a difference is generated in idle cooling performance between the case in which the idle RPM control mode is set to the second mode as represented by a reference numeral 210 and the case in which the idle RPM control mode is set to the first mode as represented by a reference numeral 220.

In addition, when reviewing the case in which twenty minutes elapse in an idle state, it may be appreciated that a lager difference is generated in idle cooling performance between the case in which the idle RPM control mode is set to the second mode as represented by a reference numeral 215 and the case in which the idle RPM control mode is set to the first mode as represented by a reference numeral 225.

As described above, the apparatus for controlling cooling sets the idle RPM control mode to the first mode in the case in which the outdoor temperature exceeds the predefined set value, thereby making it possible to increase idle cooling performance efficiency.

However, this difference in the idle cooling performance may correspond to hot weather in which the outdoor temperature exceeds the predefined set value, and a difference in the idle cooling performance between the first mode and the second mode will not be large in the case in which the outdoor temperature does not exceed the predefined set value. Therefore, the apparatus for controlling cooling sets the idle RPM control mode to the second mode in the case in which the outdoor temperature does not exceed the predefined set value, in order to improve fuel efficiency.

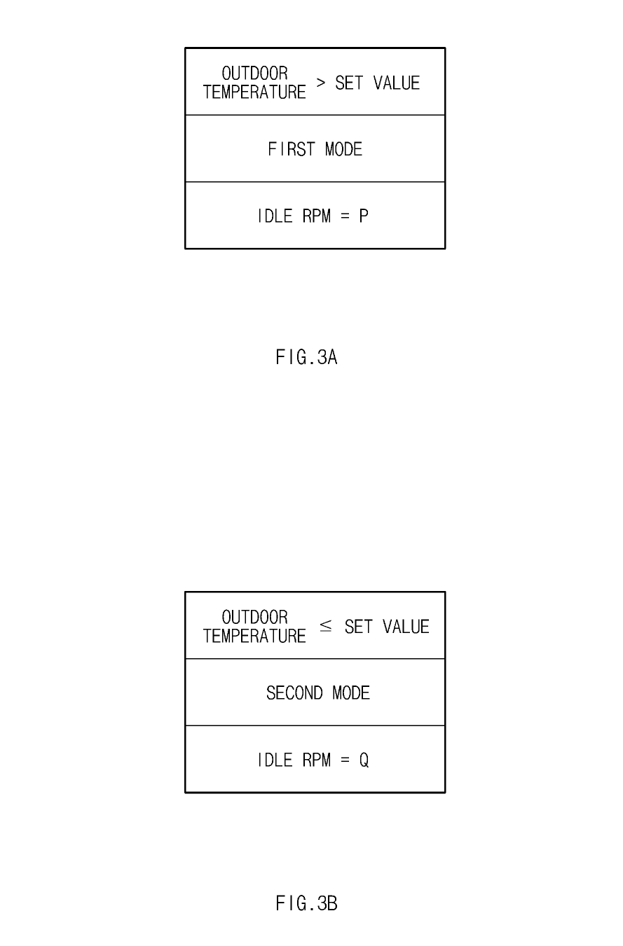

FIGS. 3A and 3B are illustrative views for describing a mode operation of the apparatus for controlling cooling according to the exemplary embodiment of the present invention.

Referring to FIG. 3A and FIG. 3B, FIG. 3A illustrates the case in which the outdoor temperature exceeds the predefined set value, and FIG. 3B illustrates the case in which the outdoor temperature is the predefined set value or less.

First, as illustrated in FIG. 3A, the apparatus for controlling cooling sets the idle RPM control mode to the first mode in the case in which the outdoor temperature exceeds the predefined set value, and sets the idle RPM to the first value, that is, P so as to correspond to the first mode. In this case, the apparatus for controlling cooling controls idle cooling of the air conditioner of the vehicle based on the P value, which is the idle RPM. As a result, the air conditioner may exhibit improved cooling performance as illustrated in FIG. 2.

Meanwhile, as illustrated in FIG. 3B, the apparatus for controlling cooling sets the idle RPM control mode to the second mode in the case in which the outdoor temperature is the predefined set value or less, and sets the idle RPM to the second value, that is, Q so as to correspond to the second mode. In this case, the apparatus for controlling cooling controls idle cooling of the air conditioner of the vehicle based on the Q value, which is the idle RPM. As a result, the air conditioner performs cooling based on the idle RPM lower than the P value, and the vehicle may exhibit fuel efficiency performance improved as compared with the first mode at the time of idle cooling.

An operation flow of the apparatus for controlling cooling according to the exemplary embodiment of the present invention configured as described above will be described below in detail.

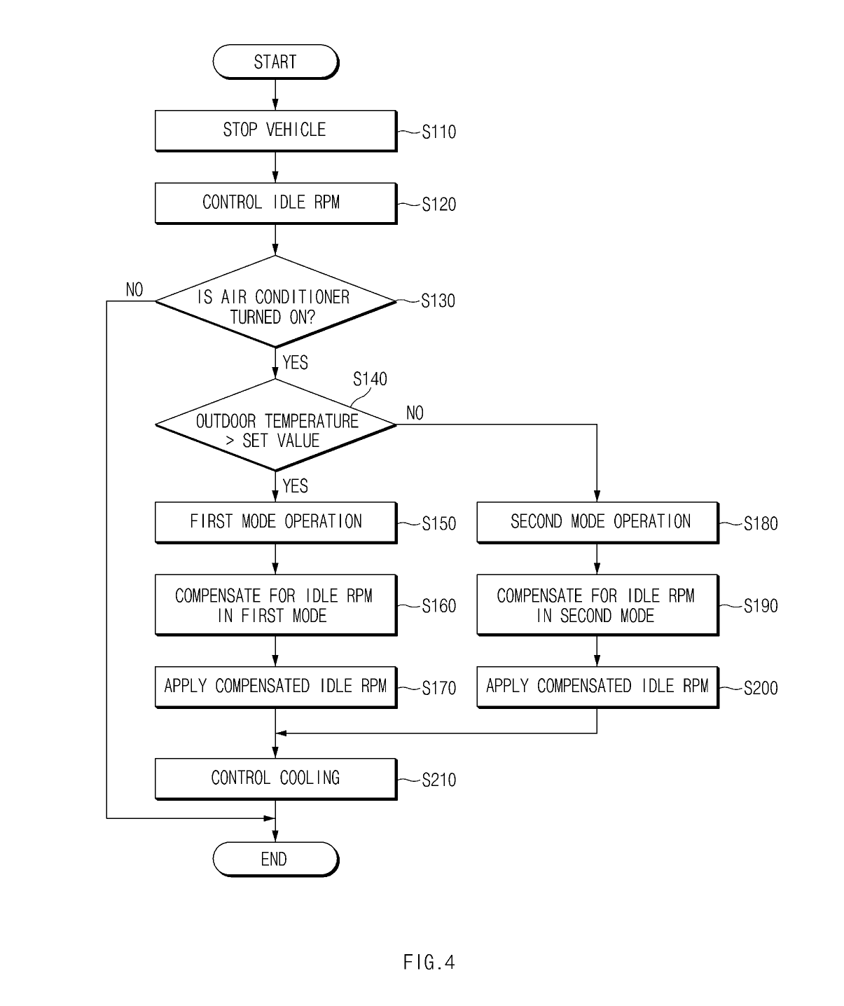

FIG. 4 is a flow chart illustrating an operation flow of a method for controlling cooling according to the exemplary embodiment of the present invention.

Referring to FIG. 4, the apparatus for controlling cooling performs the idle RPM control (S120) when the vehicle stops (S110).

Here, when an air conditioner turn-on operation request is present in the idle control state of the vehicle (S130), the apparatus for controlling cooling requests the temperature sensor to input the outdoor temperature information and compares the outdoor temperature measured by the temperature sensor and the predefined set value with each other.

Here, when the outdoor temperature measured by the temperature sensor exceeds the predefined set value (S140), the apparatus for controlling cooling sets the idle RPM control mode to the first mode (S150), and compensates for the idle RPM so as to correspond to the first mode (S160). In this case, the apparatus for controlling cooling may adjust the idle RPM to the first value corresponding to the first mode.

The apparatus for controlling cooling applies the idle RPM compensated for in S160 (S170) to control cooling of the air conditioner in the idle state of the vehicle (S210).

Meanwhile, when the outdoor temperature measured by the temperature sensor does not exceed the predefined set value (S140), the apparatus for controlling cooling sets the idle RPM control mode to the second mode (S180), and compensates for the idle RPM so as to correspond to the second mode (S190). In this case, the apparatus for controlling cooling may adjust the idle RPM to the second value corresponding to the second mode.

The apparatus for controlling cooling applies the idle RPM compensated for in S190 (S200) to control cooling of the air conditioner in the idle state of the vehicle (S210).

As described above, the apparatus for controlling cooling according to the exemplary embodiment of the present invention variably controls the idle RPM control mode depending on the outdoor temperature in the idle control state of the vehicle to apply the idle RPM adaptively to the surrounding situation, thereby making it possible to increase cooling efficiency in muggy weather and increase fuel efficiency performance in the case in which weather is not muggy.

As described above, according to various embodiments of the present invention, the idle RPM is variably controlled depending on the outdoor temperature, thereby making it possible to effectively satisfy cooling performance and fuel efficiency improvement problems depending on the outdoor temperature.

The above-mentioned processes may be directly implemented by hardware or software module executed by a processor or a combination thereof. The software module may reside in a random access memory (RAM), a flash memory, a read only memory (ROM), an erasable programming ROM (EPROM), an electrically erasable programming ROM (EEPROM), a register, a hard disk, a detachable disk, a storing device medium such as a compact disk-ROM (CD-ROM), that is, a memory and/or a storing device. An illustrative storing device medium may be coupled to a processor, which may read information from the storing device medium and write information to the storing device medium. As another method, the storing device medium and the processor may also be formed integrally with each other. The processor and the storing device medium may also reside in an application specific integrated circuit (ASIC). The ASIC may also reside in a user terminal. As another method, the processor and the storing device medium may also reside as individual components in the user terminal.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An apparatus for controlling cooling, comprising:
a deciding device configured to decide an idle revolution per minute (RPM) control mode by comparing an outdoor temperature measured by a temperature sensor and a predefined set value with each other when an air conditioner operating request is present in an idle control state of a vehicle;
a mode setting device configured to set the idle RPM control mode to at least one of a first mode and a second mode depending on the decision of the deciding device;
an RPM compensating device configured to adjust an idle RPM to a first value at a time of setting the idle RPM control mode to the first mode and adjust the idle RPM to a second value at a time of setting the idle RPM control mode to the second mode, depending on the setting of the idle RPM control mode of the mode setting device; and
a controller configured to control a cooling operation of an air conditioner depending on the idle RPM set value adjusted by the RPM compensating device.

2. The apparatus for controlling cooling according to claim 1, wherein the deciding device decides the idle RPM control mode to be the first mode in a case in which the outdoor temperature measured by the temperature sensor exceeds the predefined set value.

3. The apparatus for controlling cooling according to claim 1, wherein the deciding device decides the idle RPM control mode to be the second mode in a case in which the outdoor temperature measured by the temperature sensor does not exceed the predefined set value.

4. The apparatus for controlling cooling according to claim 1, wherein the first value is larger than the second value.

5. The apparatus for controlling cooling according to claim 1, wherein the second value is a reference idle RPM.

6. A method for controlling cooling, comprising:
deciding, by a deciding device, an idle RPM control mode by comparing an outdoor temperature measured by a temperature sensor and a predefined set value with each other when an air conditioner operating request is present in an idle control state of a vehicle;
setting, by a mode setting device, the idle RPM control mode to any one of a first mode and a second mode depending on the decision;
adjusting, an RPM compensating device, an idle RPM to a first value at the time of setting the idle RPM control mode to the first mode and adjusting the idle RPM to a second value at the time of setting the idle RPM control mode to the second mode; and
controlling, by a controller, a cooling operation of an air conditioner depending on the adjusted idle RPM set value.

7. The method for controlling cooling according to claim 6, wherein in the deciding of the idle RPM control mode, the idle RPM control mode is decided to be the first mode in a case in which the outdoor temperature measured by the temperature sensor exceeds the predefined set value.

8. The method for controlling cooling according to claim 6, wherein in the deciding of the idle RPM control mode, the idle RPM control mode is decided to be the second mode in a case in which the outdoor temperature measured by the temperature sensor does not exceed the predefined set value.

9. The method for controlling cooling according to claim 6, wherein the first value is larger than the second value.

10. The method for controlling cooling according to claim 6, wherein the second value is a reference idle RPM.
